(19) United States
(12) Patent Application Publication
(10) Pub. No.: US 2011/0287402 A1
(43) Pub. Date: Nov. 24, 2011

(54) Method and apparatus for novel embodiments to repurpose eink ereaders as writing devices to enable children to write on digital workbook learning content

(76) Inventor: Michael Sanford, Dallas, TX (US)

(21) Appl. No.: 13/136,187

(22) Filed: Jul. 26, 2011

Related U.S. Application Data
(63) Continuation-in-part of application No. 11/894,203, filed on Aug. 20, 2007, now abandoned.
Application No. 11/894,203 is a continuation-in-part of application No. 11/888,824, filed on Aug. 2, 2007, now abandoned.
(60) Provisional application No. 61/400,342, filed on Jul. 26, 2010.

(51) Int. Cl. B43L 1/00

(52) U.S. Cl. 434/408

(57) ABSTRACT

A method and apparatus is put forth in this unique invention that together transform readily available consumer eReaders, such as various models of Amazon Kindles and the Barnes and Nobel Nook, into repurposed digital learning devices which can then also serve as digital writing platforms for children and others to write on digital workbooks and other learning content of the inventor's design, covered in previous patent applications, as appended hereto. The various embodiments of Space Cases, Writing Shields and the Micro Eraser device described herein provide a new family of tutoring apparatuses, along with a unique set of learning methodologies that result in transforming standard off-the-shelf eInk-based eReaders, into low-cost and effective 21^{st} century digital learning tools for our young children to use before, during and after school, as well as at home or while traveling, to enhance and to improve their learning experience and their mastery of the learning content presented by using handwriting in digital form.

### CROSS REFERENCE TO RELATED APPLICATIONS

The present application is a continuation-in-part of the following pending US applications, and incorporates by reference hereinto the entirety of such applications: Application Serial Number: (Number Unknown), filed 7 Jan. 2011, and titled: METHOD AND APPARATUS FOR ELECTRONIC WORKBOOKS, FLASHCARDS AND OTHER DIGITAL LEARNING CONTENT AND SOFTWARE FOR USE WITH A VARIETY OF BOTH CUSTOM AND OFF THE SHELF EINK EREADERS, IPADS AND ANDROID-TYPE TABLETS, Attorney Docket No, 0255 MH-43347; which is a CIP of Ser. No. 11/894,203, filed 20 Aug. 2007, and titled: METHOD AND APPARATUS FOR ELECTRONIC WORKBOOK/TEXTBOOK WITH DIGITAL CONTENT FOR STUDENT'S ACCELERATED LEARNING, SELF-TUTORING AND SELF-ASSESSMENT, Attorney Docket No: 0255 MH-43110; and Ser. No. 11/888,824, filed 2 Aug. 2007, titled METHOD AND APPARATUS FOR STUDENTS' ACCELERATED LEARNING, SELF-ASSESSMENT AND SELF-TUTORING OF STUDY MATERIALS AND OTHER INFORMATION, Attorney Docket No. 0255 MH-43099.

Further, this application claims benefit of the following U.S. provisional applications, and incorporates by reference hereinto the entirety thereof: Application No. 61/400,342, filed 26 Jul. 2010, titled METHOD AND APPARATUS FOR NOVEL EMBODIMENTS OF ELECTRONIC WORKBOOK/TEXTBOOKS AND DIGITAL LEARNING CONTENT AND SOFTWARE FOR USE WITH A VARIETY OF OFF THE SHELF EINK EREADERS, INCLUDING THOSE WITH A DIGITAL STYLUS FOR WRITING, Attorney Docket No. 0255 MH-43359P; and Application No. 61/400,342, filed 27 Aug. 2010, titled METHOD AND APPARATUS FOR NOVEL EMBODIMENTS FACILITATING THE USE OF A VARIETY OF OFF THE SHELF EINK EREADERS, INCLUDING THE AMAZON KINDLE2, KINDLE 3, KINDLE DX AND THE APPLE IPAD AS WRITING DEVICES FOR USE WITH DIGITAL LEARNING CONTENT, Attorney Docket No. 0255 MH-43360.

### BACKGROUND OF THE INVENTION

1. Field of the Invention

The method and apparatus of the present invention relates to devices which assist children in learning through writing by hand with a dry erase marker on commercially available eReaders and is applicable primarily for young children (PreK through 6^{th} Grade) but also may apply to older students, as in those attending middle school through high school and is further applicable to adults for university-level study, as well as vocational and business training applications through a variety of learning and tutoring applications.

2. Description of the Prior Art

It seems almost trite to say that the United State's public schools are in trouble. Students are not learning effectively, high school student dropout rates are increasing and budgets are tight and getting tighter. There is a growing shortage of qualified and effective teachers. The use of new technology that is used directly by the student to enhance his or her learning experience and mastery of the learning content has not kept up with technological advances of the consumer, business, healthcare and industry. As a result, our students are working with antiquated technology still, not the least of which are ink on paper printed workbooks and textbooks, a sixteenth century technology that our children still lug back and forth to school by the tons every single school day.

Moreover a growing body of medical and scientific evidence now shows that it is critically important for children, particularly from the ages of PreK to about the 6^{th} grade (the on-set of puberty for most children) to write by hand in order to acquire proper visual motor integration, grasp, retain and express concepts, as well as to further proper physical brain and neural development. In the words of one writer “Writing by hand makes Kids Smarter”.

In the words of another article on the subject entitled “How handwriting trains the brain”, children, particularly younger children are texting, using a mouse or a touch screen computer, typing on a keyboard or doing just about anything except writing with a writing instrument on a paper or other writing surface. Many schools have simply abandoned handwriting, or pay scant attention to it, as there have been few learning digital devices that employ handwriting as the means of interacting with the learning content . . . few as in virtually none.

The inventor has developed and filed numerous patent applications for a methodology and various forms of apparatus using eInk type and other devices designed specifically for student's use. The inventor is working to develop those new devices and productize them over the next few years. However, the explosion over the past few years of commercially available eInk based eReaders designed for adult consumers presents an opportunity for innovative repurposing of these devices which will result in low-cost digital learning platforms that can be used by public school students today. This repurposing through the present invention, apparatus and methods set forth in this application results in such devices currently on the market as just eReaders to be “used” (or even “reused”, if they have been abandoned or discarded) as electronic workbooks and textbooks. To coin a new phrase, the present invention transforms eReaders into eWriters.

There have been an estimated 15 million Amazon Kindle eReaders sold over the past few years and more than a 10 million Barnes and Noble Nook eReader. The current “market price” for the currently marketed six-inch display screen Kindle device is $114, down more than 400% from its original price of over $400 just a few years ago. Likewise, the Barnes and Noble Original Nook device is priced at less than $150. Thus the price point for all eReaders is dropping rapidly as competition heats up, manufacturing quantities scale up and market demand increases from an ever-growing eReader savvy consumer marketplace.

While there is perhaps nothing particularly “novel” about a “case” that holds and protects the display screen and, if applicable, the keyboard, of an eReader when not in use, much as a book jacket does a paperback book, there is no device which has been developed that will not only protect the eReader with small children using it, but additionally makes it possible for the child to write on the screen and store all the implements required for doing so, namely a micro eraser and dry erase marker.

For example, there are hundreds of “plain” protective cases that are simply covers designed to protect the surface area, keyboard and display screen of the eReader. These may also be not so plain “designer series”, which in some instances cost more than the eReaders itself. Other “covers” also incorporate such helpful items as a “reading light” or fold in such a manner to serve as an easel for more comfortable reading on a flat surface, such as a table.

Then there are also actual “cases” some of which are little more than clear plastic bags which provide a level of water proofing, or at least “splash proofing” and protection from dust or sand (such as on a beach or by a swimming pool or the ocean). An ultra embodiment of this type case is the KlearKase, which is made of translucent polycarbonate plastic, this being a plastic that can be used in some forms of “body armor”. It provides the ultimate in “hazard protection”, but again, costs about half the retail price of the actual Kindle eReader itself.

Previous patent applications by this inventor referenced above include novel inventions, apparatus and methods resulting in a new generation of workbooks and learning content. This inventor's designs provide unique solutions in both analog and digital form that provides a quick and easy methodology for students to be self-tutored using the devices and then “self-assess” (check their own answers themselves that they handwrote in the various workbook designs) quickly and easily. All the learning content developed by the inventor is self-paced, employs guilt-free repetition that facilitates mastery of the material to be learned, in a scaffolding, step by step process.

This inventor's first embodiment of such a device that would facilitate children's being able to write on a commercially available eReader device and the inventor's novel digital learning content was the “Space Capsule”, as described in inventor's utility patent filed in January 2011. This was a relatively large footprint device that stored an eraser and the dry erase marker outside of the case by using Velcro attached to both the Space Case device as well as to the eraser and marker. The manufacture of this device was labor intensive, with regard to the application of Velcro, not only to the marker and eraser, but also to the closing mechanism to hold the eReader in the device, so that it could be written on.

The new embodiments of the preferred inventions set forth in this patent application provide additional solutions seeking to achieve those results using mass-produced consumer eReader products in concert with and corresponding to the functionalities and methodologies of the inventor's digital learning system. The result is a low-cost, new generation of learning devices and learning content available for student use today and in the coming years, even as the inventor's newer custom devices go into production. The new devices, namely the “Space Case”, “Micro Eraser” and “Writing Shields” are extremely low-cost to manufacture, which is critically important because of the declining prices in eReaders and to achieve critical mass in the marketplace.

In the case of a $180 designer cover for a $114 Kindle, one has what we call a Texas “a $10 horse with a $20 saddle”. There is likewise a relationship of the price for a Space Case or Writing Shield to the retail price of its intended eReader, particularly when “repurposing” abandoned or discarded eReaders, which may have little “commercial” value, but which could become badly needed digital learning platforms, if only a Space Case or Writing Shield could be provided for use with it. The target retail price for the Space Case is $19.85 (including the Micro Eraser) and the target retail price for the writing shields is $4.95 (also including the Micro Eraser). A used, discarded and “obsolete” older Kindle may only be worth less than $50, if anything at all. The goal is to transform millions of otherwise under-used or not-used eReaders into low-cost, portable digital reading and writing platforms for millions of younger children.

Unlike any other eReader cover or case, the Space Case embodiment of the present invention provides storage for a dry erase marker and a micro eraser. Further, it provides a clear acrylic panel securely positioned over the eReaders eInk display screen to facilitate writing on the inventor's or other digital workbook content displayed on the eReader's screen.

The Space Case also features a closeable plastic latch, in place of the Velcro latching on the inventor's earlier Space Capsule device, to open or secure the cover. It also has cut-outs in the cover to facilitate the user accessing controls on the eReader. Like the Space Capsule before it, the Space Case features over-molded (heat bonded, rather than glued on) traction feet on the bottom side of the device to provide a non-skid writing platform when placed on a desk or table.

The Space Case also features a label insert cavity on the top cover to provide for private labeling, which could be the company logo and information of a manufacturer or distributor, or even the name and colors of the child's school. Because the device is manufactured using an injection molding process, it can employ strong plastic materials, is low-cost (less than $5 manufacturing cost per unit) can be easily manufactured by the tens of thousands and can be “shot” in a variety of “cool kid colors” plastics, attracting children to use the “cool digital learning device” to write on using the inventor's equally cool digital learning content.

Further, there is a unique embodiment of a micro eraser, which is uniquely fashioned to be manufactured using an injection mold process. While most small plastic erasers for children have a “handle” (a T shaped area running down the middle of the eraser) or are made out of simple wood and are flat and solid, the embodiment of the present invention's micro eraser is unique in its shape, its ability to be easily used by small hands, its low profile (reducing the height of the Space Case for a given eReader) and its low cost by using this manufacturing process, reducing costs to just pennies per micro eraser.

There is also an embodiment of the present invention set forth in this application for a Writing Shield, comprised of a clear-thin sheet clear sheet of acrylic or lexan (polycarbonate) plastic, which provides an extremely low-cost and portable method (i.e. easily fits in a shirt pocket or purse) facilitating children's writing on digital workbook content also using standard eReaders such as the Kindle or Nook. Unlike “screen shields” which are common extremely thin sheets of clear plastic with an adhesive backing, meant to adhere to the eReader's display screen until is the clear plastic wears out, and then be replaced by another “screen shield” (usually sold three to a pack, for just such occasions), the Writing Shield has no adhesive backing.

The Writing Shield features a “finger notch” along any one of the four sides of the device. With the finger notch, the user can simply use the tip of one finger to facilitate its extraction from laying on top the eReader's display screen, as it is secured only laterally by the inset area surrounded by the eReader's display screen frame. Another method of removing the Writing Shield is simply to invert the eReader holding it in one hand and catch the Writing Shield in the palm of the other hand. If that is the preferred method of removal, then the finger notch is not necessary, and would reduce production costs slightly, depending on the manufacturing method. However, with the finger notch, there's one less chance of the eReader being dropped by small hands and damaged, while inverting it to remove the Writing Shield.

The Writing Shield can be manufactured out of 1/32″ clear acrylic plastic using high-speed, compute driven CNC rotary router cutting tool, or from 1/64″ clear lexan, die cutting (stamping them out) from sheets of that clear plastic material. In either case the finished Writing Shields are silk screened with company information, logo after being cut and shaped.

Because the Writing Shield is designed to be written on by a child or other person using a dry erase marker and those markings must be removed by use of a micro eraser, which is felt (or other material) backed, the Writing Shield is simply removed after use by turning the eReader upside down (it fits loosely in the screen display frame), and the eReader is used parallel to the writing surface such as a desk or table. Then the Writing Shield can be easily cleaned with just water or a micro cleaning cloth and stored until time for its next use.

Finally, there is a further embodiment of the Writing Shield that is superior to the first two embodiments, while also costing more to set up to produce because it requires the manufacturing of an injection mold. It features a much more “finished” look, is stronger, and is produced at a fraction of the per-unit cost of either the router-cut clear acrylic panel or the die-cut lexan-polycarbonate devices. This embodiment has two component parts: the injection molded “frame” which features a “finger lift” incorporated into it which replaces the “finger notch” in the other two Writing Shield embodiments, and a 1/32″ cut-sheet clear acrylic panel, which is inserted into and sonic welded to the frame. Using simple cut-sheets of acrylic, which cost a fraction of CNC router-cut formed panels, is the major reason for the dramatic cost-savings of this manufacturing process over the prior two embodiments of the present invention.

### SUMMARY OF THE INVENTION

In accordance with the present invention, a method and apparatus is provided that allows marking to be made by a user responding to digital pages of learning content in the form of eBooks. The pages of the digital workbook are displayed on the commercially available eReader, which is encapsulated in a device called a “Space Case” which includes a clear plastic panel covering said eReader, allowing the user to respond to the digital learning content by handwriting or drawing the user's responses with a dry erase marker onto the clear plastic panel, and erasing the markings with a novel and unique “Micro Eraser” when through with a given page's interactions. The Space Case also features traction feet which provide lateral stability while writing on a flat surface. The dry erase marker and Micro Eraser are stored inside the Space Case device when not in use. An even simpler device is also provided in accordance with the present invention in the form of various embodiments called “Writing Shields”, which also facilitate writing on commercially available eReaders with a dry erase marker, but which do not encapsulate the eReader, but rather are simply placed directly on the eReader's screen display, and then removed when the user has completed writing on the digital workbooks.

### BRIEF DESCRIPTION OF THE DRAWINGS

The novel characteristics of the invention are set for the appended claims. The invention itself, as well as a preferred mode of use, further objectives and advantages thereof, will best be understood by references to the following detailed description of the preferred embodiment when read in conjunction with the accompanying drawings.

For the purposes of this description, the Amazon Kindle LG (“LG” standing for “latest generation), also referred to by some as the Kindle 3, and now, by Amazon simply as “the Kindle” references the now current version of the Amazon Kindle, released in August 2010. The “Older Kindle”, previously referred to by Amazon as the Kindle 2, is the immediate predecessor to the now current Kindle LG.

FIG. 1 is a pictorial representation of the front view of an exemplary device (empty) for use with an Amazon Kindle LG eInk-based eReader (hereafter referred to simply as “the Kindle LG”) in accordance with the preferred embodiment of the present invention.

FIG. 2 is a pictorial representation of the top side, top perspective and side views of an exemplary device (empty) for use with the Kindle LG in accordance with the preferred embodiment of the present invention.

FIG. 3 is a pictorial representation of the bottom side and bottom perspective views of an exemplary device for use with the Kindle LG in accordance with the preferred embodiment of the present invention.

FIG. 4 is a pictorial representation of a frontal-perspective view of an exemplary device with the cover open, showing the requisite components required to write on the Kindle LG when it is placed in the Space Case, namely the Kindle LG, the eraser and the dry erase marker stored in their proper “wells” within the device in accordance with the preferred embodiment of the present invention.

FIG. 5 is a pictorial representation of a top perspective view of an exemplary device showing the various components required to write on the Kindle LG removed from the Space Case, showing the storage wells of the device in accordance with the preferred embodiment of the present invention.

FIG. 6 is a pictorial representation of a front view of an exemplary device showing the Kindle LG placed inside the device such that it can be written on using the dry erase marker and eraser provided with the device in accordance with the preferred embodiment of the present invention.

FIG. 7 is a pictorial representation of the top view of an exemplary device, called a Space Case designed and configured to facilitate the use of the Older Kindle as a writing device in accordance with the preferred embodiment of the present invention.

FIG. 8 is a pictorial representation of top, bottom and side views of the Space Case with the Older Kindle in place inside of it in accordance with the preferred embodiment of the present invention.

FIG. 9 is a pictorial representation of the Space Case with the cover open showing the components stored in their respective wells in accordance with the preferred embodiment of the present invention.

FIG. 10 is a pictorial representation of the Space Case for the Barnes and Nobel Nook eReader, showing the Nook in place in side of it in accordance with the preferred embodiment of the present invention.

FIG. 11 is a pictorial representation of top and bottom perspective views of the Space Case for the Nook, with the Nook in place inside of it in accordance with the preferred embodiment of the present invention.

FIG. 12 is a pictorial representation of the top view of the Space Case for the Nook with the cover open showing the writing components and the Nook eReader outside of the device in accordance with the preferred embodiment of the present invention.

FIG. 13 is a pictorial representation of the top view of the Space Case for the Nook with the cover opened and with the writing objects and the Nook in place inside in accordance with the preferred embodiment of the present invention.

FIG. 14 is a pictorial representation of the top and bottom perspective views of the Space Case for the Amazon Kindle DX in accordance with the preferred embodiment of the present invention.

FIG. 15 is a pictorial representation of the Space Case for the Kindle DX with the cover open and the writing objects and the Kindle DX in their respective storage wells in accordance with the preferred embodiment of the present invention.

FIG. 16 is a pictorial representation of the Space Case for the Kindle DX with the cover open and the writing objects and the Kindle DX removed from the device in accordance with the preferred embodiment of the present invention.

FIG. 17 is a pictorial representation showing top, bottom, side and perspective views of the injection-molded Space Case Eraser in accordance with the preferred embodiment of the present invention.

FIG. 18 is a pictorial representation of the Writing Shield with the Finger Notch located on one of the shorter ends of the device in accordance with the preferred embodiment of the present invention.

FIG. 19 is a pictorial representation of the Writing Shield being inserted onto the display screens of an Older Kindle, a Kindle LG and a Nook eReader in accordance with the preferred embodiment of the present invention.

FIG. 20 is a pictorial representation of an alternative placement of the Finger Notch on a Writing Shield for a Kindle LG, Older Kindle or Nook in accordance with the preferred embodiment of the present invention.

FIG. 21 is a pictorial representation showing front, back and side cut-away views of another embodiment of the present invention, manufacturing Writing Shields by way, of using an injection-molded Frame and inserting lower-cost cut-sheet clear Acrylic panels in accordance with the preferred embodiment of the present invention.

FIG. 22 is a pictorial representation showing the insertion of the cut-sheet clear Acrylic panel into the back of the Writing Shield and sonic welding (or gluing) it to the Frame in accordance with the preferred embodiment of the present invention.

### DESCRIPTION OF THE PREFERRED EMBODIMENTS

The present invention is a method and apparatus which includes a device, called a “Space Case” which encapsulates a commercially available, mass-produced eReader, such the Amazon Kindle and allow it to be used as a platform for using digital workbooks, upon which a student can read, handwrite exercises, do practice work and then answer questions in handwritten form and check those answers immediately using this inventor's learning content and tutoring methodologies. This approach is in no way limited to Amazon Kindles and Barnes and Noble Nook eReaders but can and will be used with a virtually unlimited variety of other such eReader devices.

In this embodiment, the inventor's devices feature a clear acrylic panel positioned over the eReader's eInk display, such that the student can write over the display using a dry erase marker. The inventor's device for eReaders also may selectively cover certain control buttons on the eReader, such as the keyboard or menu buttons that are not needed by the child or student when using digital work books. Such buttons may also cause confusion for the student if inadvertently pressed, such as bringing up selection options not normally used by them and or might allow the student to purchase eBooks on-line. Such features such as browsing the Internet or purchasing new books on-line are then made un-available to the student, at least as long as the eReader remains inside the inventor's Space Case device.

The present invention also includes a novel dry erase micro eraser, which is designed specifically to be manufactured using commercial injection molding processes, and features an extremely low profile, so as to take the least amount of space in the Space Case. It also features a label insert cavity for low-cost customization of durable multi-color silkscreened acrylic labels and can have any number of eraser materials adhered to the erasing surface, from felt to micro-fiber materials.

In the final instance, the device assumes use of a removable rigid clear acrylic panel or one that is made of flexible latex plastic, called a Writing Shield, which in either case would be placed directly on top of the eReader's eInk display screen while said eReader is laying flat on a writing surface such as a table or desk or even in a child's lap. A finger notch in one of the four sides supports lifting the device off the eReaders screen display without having to invert the eReader. This device can be cut from ridged 1/32″ clear acrylic plastic using a CNC router, or die cut from 1/64″ flexible lexan plastic.

Or in a third and most preferred embodiment of the Writing Shield invention, one can use cut-sheet clear acrylic 1/32″ plastic which is then sonic welded into an injection molded frame. The frame provides the exact fit into the eReader screen display area (bordered by the eReader's screen display cavity) and providing a smoother, more finished, with more rounded edges and a more consistent and exact fit onto the eReader's display screen. Cutting the clear acrylic into right angle panels (a fraction of the cost of CNC routing) need not be to the same exacting tolerances as the “un-framed” versions of the device, and hence the cost is significantly less in manufacturing this version. Also the injection molded frames can be “shot” in a variety of color plastic and silkscreened with logos, and other company or school information, as required.

The novel features believed to be characteristic of the present invention are set forth in the appended claims The invention itself, as well as the preferred mode of use, further objectives and advantages thereof, will best be understood by reference to the following detailed description of the preferred embodiment when read in conjunction with the accompanying drawings, wherein:

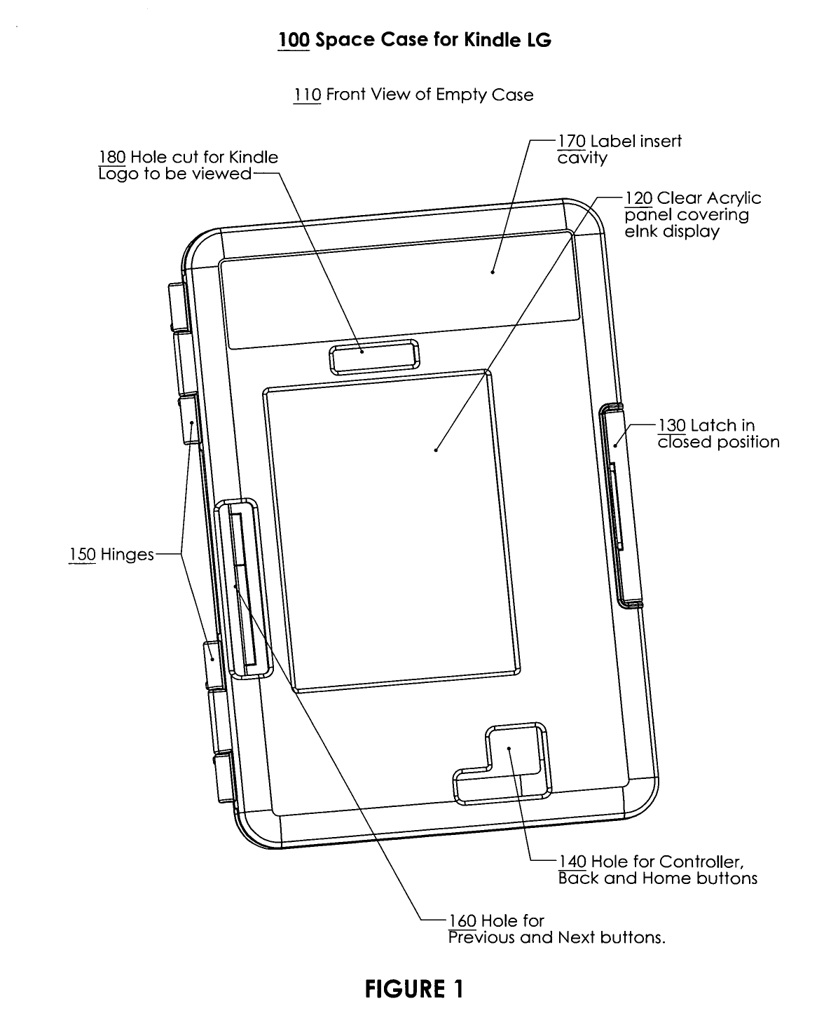

FIG. 1 is a pictorial representation of the front view 110 of an exemplary device (empty) for use with an Amazon Kindle LG eInk-based eReader (hereafter referred to simply as “the Kindle LG”) in accordance with the preferred embodiment of the present invention 100. Pictured is the clear acrylic panel 120 that is used to cover the eReader's display screen and to facilitate writing on the digital workbooks using a dry erase marker and eraser, as shown in views in later figures in this document. The Space Case cover is hinged 150 and is secured when in closed position by use of a latch 130 thus holding the eReader and the writing components in-placed when taken on the road by the parent or child. The cover of the Space Case is configured with cut-out holes that provide access the control buttons on the eReader, such as for the previous and next buttons 160 the controller, back and home buttons of the eReader 140 and one that allows the Amazon logo to show through and be visible to the user of the device 180. The cover also includes a label insert cavity 170, which makes it easy to customize the cover with durable silk-screened labels. Such labels might show the logo of the distributor of the device, or even the school mascot and colors of the students using the device.

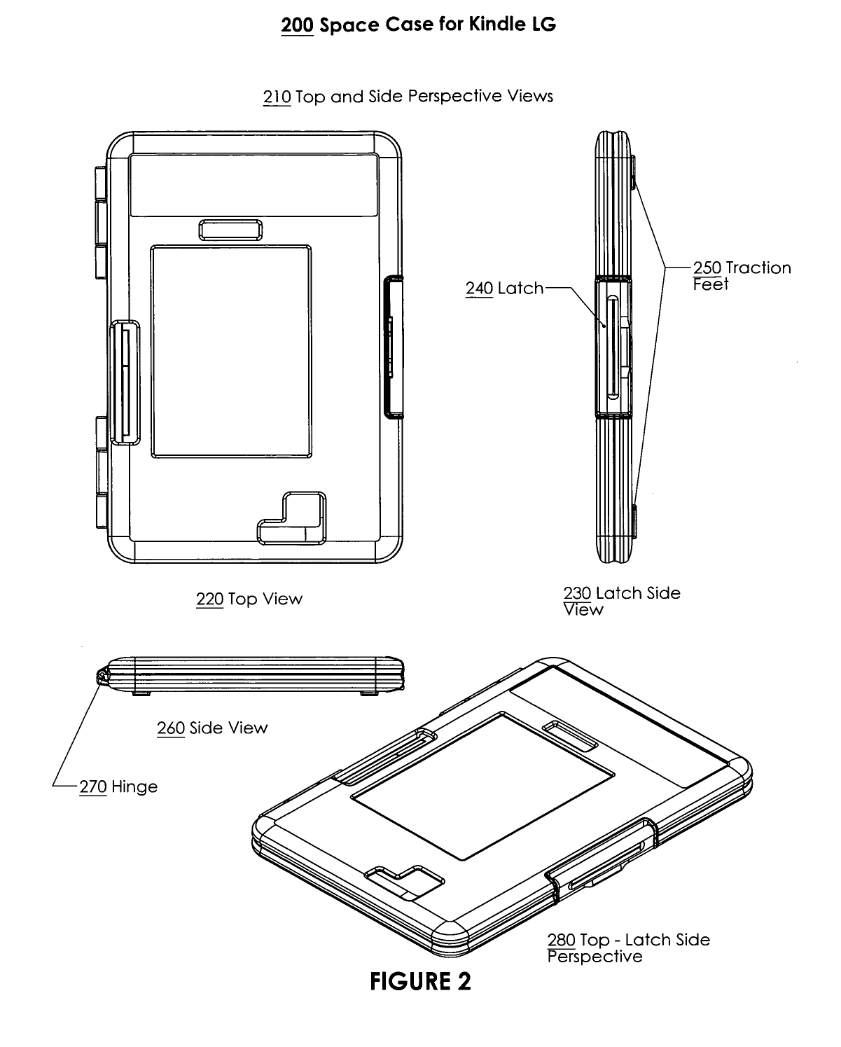

FIG. 2 is a pictorial representation of the top side, top perspective and side views 210 of an exemplary device (empty) for use with the Kindle LG in accordance with the preferred embodiment of the present invention 200. Shown is a latch-side view 230 displaying the latch assembly 240 as well as a side view of the traction feet 250 that are located on the bottom of the device. Also shown is a side view 260 showing the hinge assembly 270. A top latch-side perspective view 280 further shows the design and layout of the Space Case for the Kindle LG.

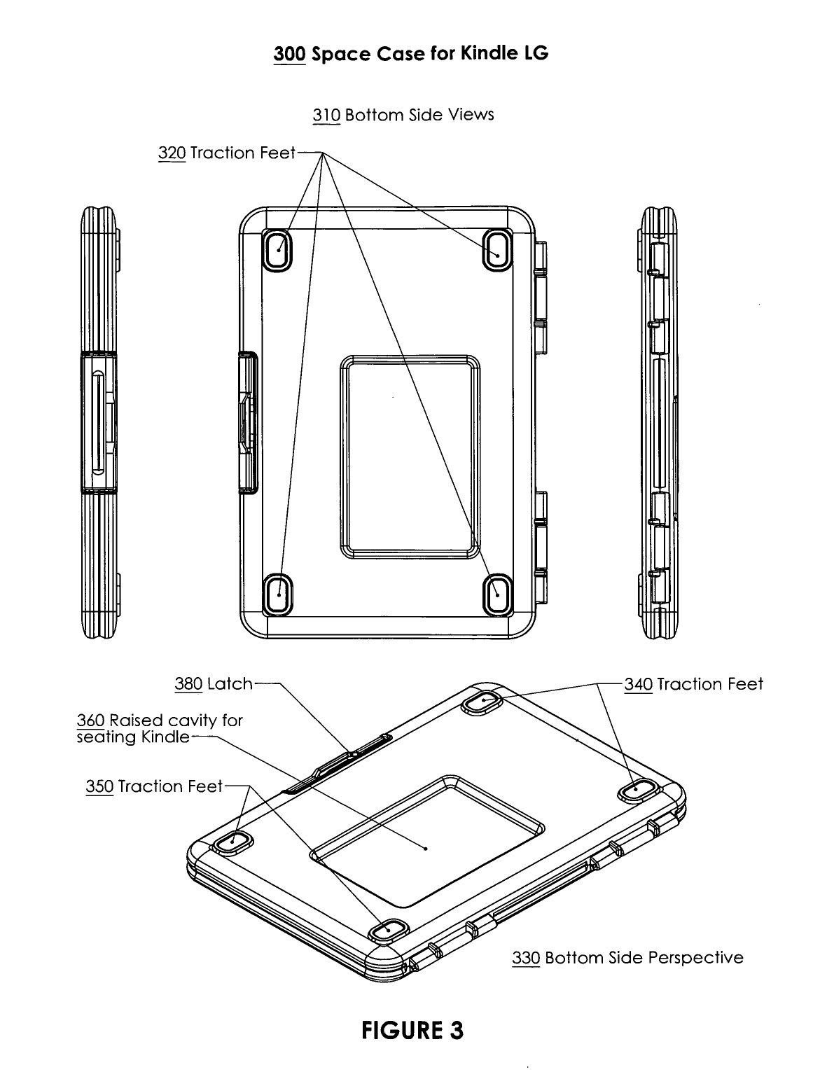

FIG. 3 is a pictorial representation of the bottom side and bottom side perspective views 310 of an exemplary device for use with the Kindle LG in accordance with the preferred embodiment of the present invention 300. Shown are the traction feet 320 which are over-molded as part of the actual case itself with a heat bonding process instead of gluing, sonic welding or other manufacturing process for safety and durability. Also shown in the bottom side perspective view 330 is the raised seating cavity 360 on the back side of the device for seating the Kindle at the appropriate height in relation to the clear acrylic panel. This view also gives another depiction of the traction feet 340 and 350 as well as another view of the latch.

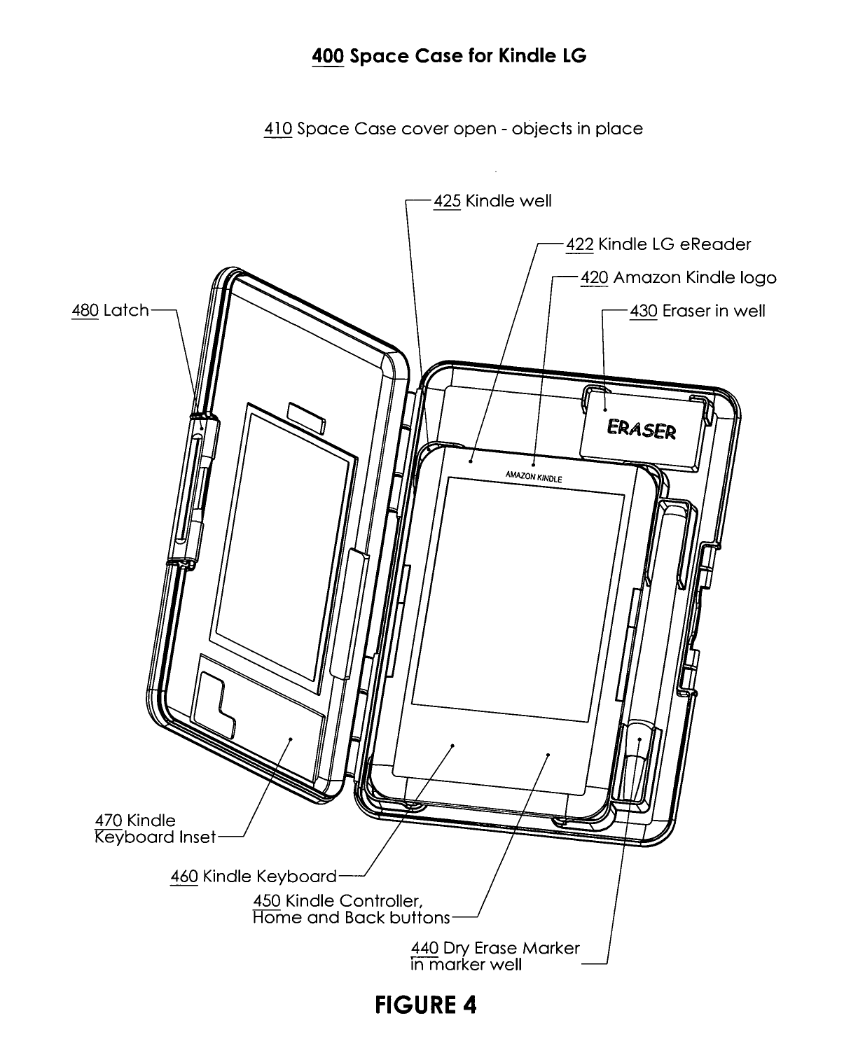

FIG. 4 is a pictorial representation of a frontal-perspective view 410 of an exemplary device with the cover open, showing the requisite components required to write on the Kindle LG when it is placed in the Space Case, namely the Kindle LG, the eraser and the dry erase marker stored in their proper “wells” within the device in accordance with the preferred embodiment of the present invention 400. Shown are the dry erase marker in its storage well 440 the micro eraser in its eraser well 430 the Kindle LG eReader 422 in place inside of the Kindle well 425. Unique features of the cover include the Kindle Keyboard Inset 470 which provides a space between the surface of the Kindle and the cover, such that pressure is not applied to the Kindle's keyboard 460, thus causing unintended response from the Kindle, such as giving it a command. Cut-outs in the cover also allow the Kindle controller, home and back buttons 450 to be accessible when the cover is closed and for the Kindle logo 420 to be visible through the cover when the cover is closed and secured with the latch 480.

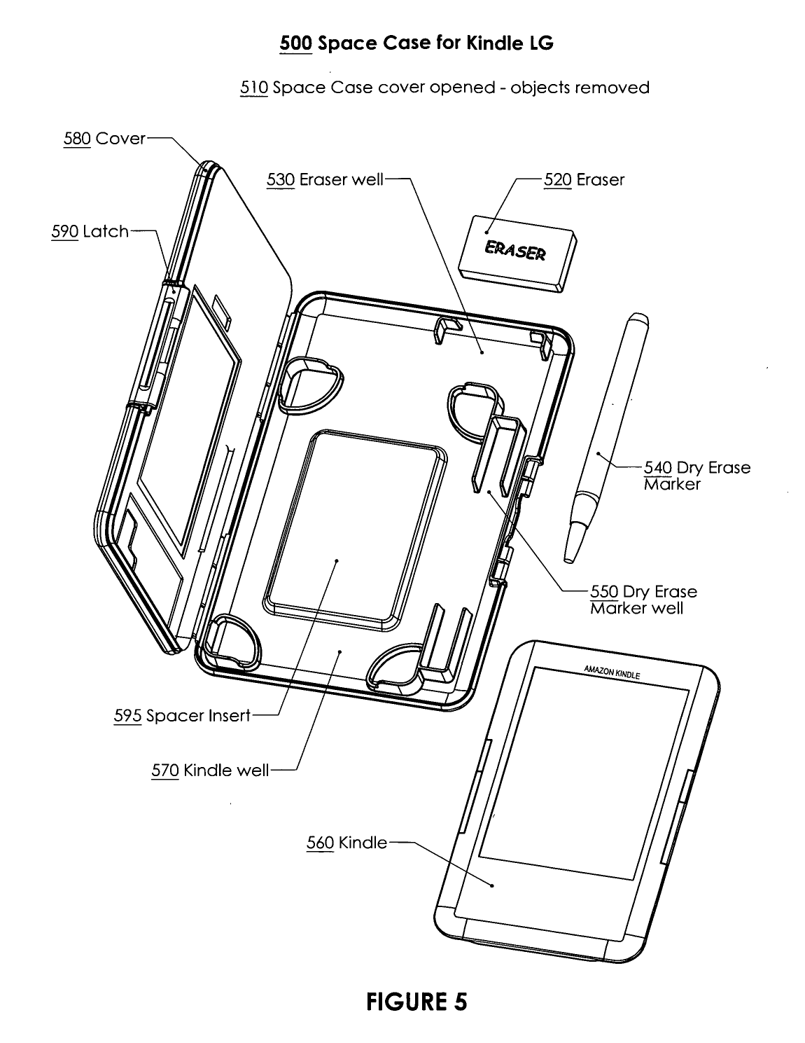

FIG. 5 is a pictorial representation of a top perspective view 510 of an exemplary device showing the various components required to write on the Kindle LG removed from the Space Case, showing the storage wells of the device in accordance with the preferred embodiment of the present invention 500. In this view the cover 580 is also open but the Kindle 560 has been removed along with the other components stored in the device to facilitate writing, namely the dry erase marker 540, which was removed from the dry erase marker well 550 and the micro eraser 520 which has been removed from the eraser well 530. With the Kindle removed from the device, the spacer insert 595 is now visible, as it is used to put the Kindle in the proper position relative to the cover 580 when it is closed and secured with the latch 590.

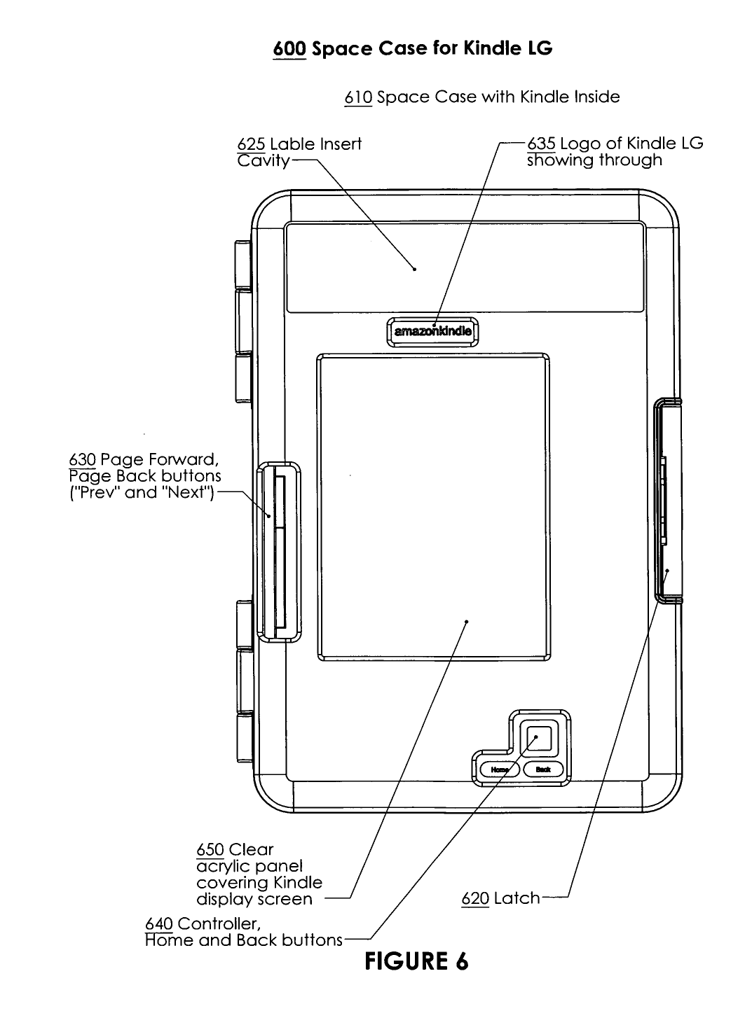

FIG. 6 is a pictorial representation of a front view 610 of an exemplary device showing the Kindle LG placed inside the device such that it can be written on using the dry erase marker and eraser provided with the device in accordance with the preferred embodiment of the present invention 600. The cover is shown closed and secured using the latch 620. Shown are the label insert cavity 625 into which may be easily inserted custom labels which may be easily mass produced in color multiple up, cut and inserted into each device, which is far less expensive than silk-screening individual devices. Also shown is the Amazon.Kindle logo that is on the Kindle showing through the cut out on the cover 635. The controller, home and back buttons 640 and the page forward and page back (“Prev” and “Next) buttons 630 likewise not only show through on the Kindle but can be fully utilized by the user to advance the page displayed, load the next workbook or return to the main menu. The child or other user writes on the clear acrylic panel covering the Kindle display screen 650 using a dry erase marker as depicted in earlier figures.

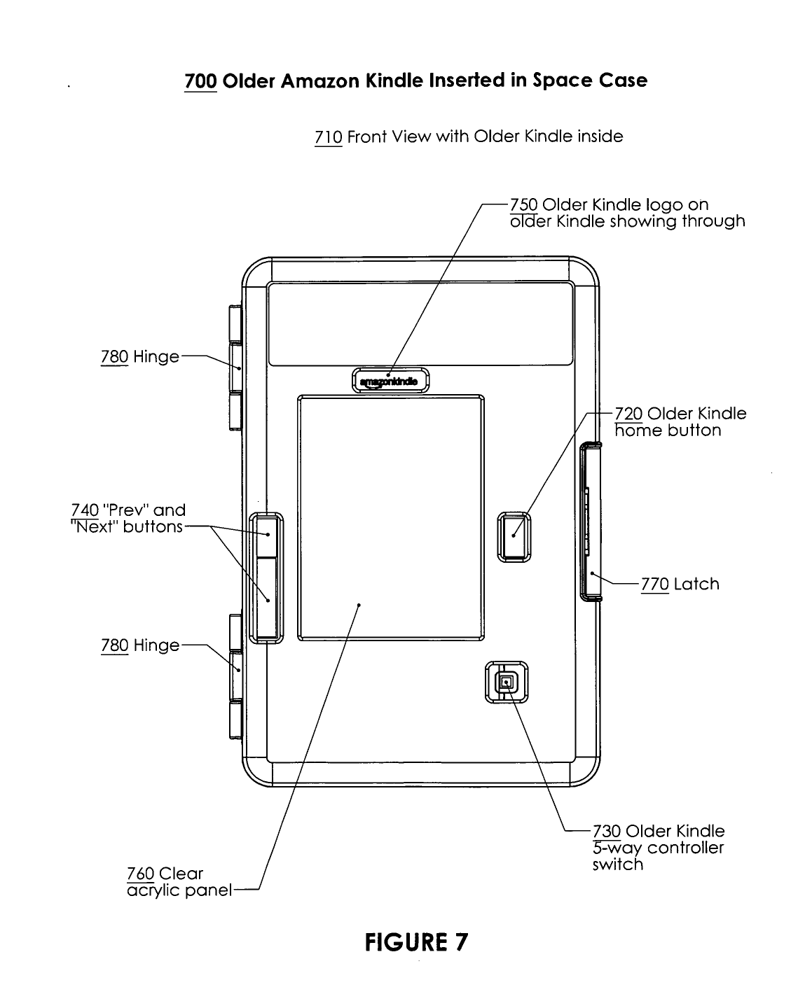

FIG. 7 is a pictorial representation of the top view 710 of an exemplary device, called a Space Case designed and configured to facilitate the use of the Older Kindle as a writing device in accordance with the preferred embodiment of the present invention 700. This shows the configuration and arrangement of the cover to facilitate the placement of the buttons peculiar to the Older Kindle but the basics of the hinges 780, latch 720 and clear acrylic panel 760 remain virtually identical in all the embodiments of the Space Board. The cut-outs in the cover for the Older Kindle logo 750, the home button 720 which is located away from the 5 way controller switch 730 and the positioning of the Prev and Next buttons 740 are all positioned specifically to accommodate their unique positions relative to the Older Kinder, versus the newer Kindle LG

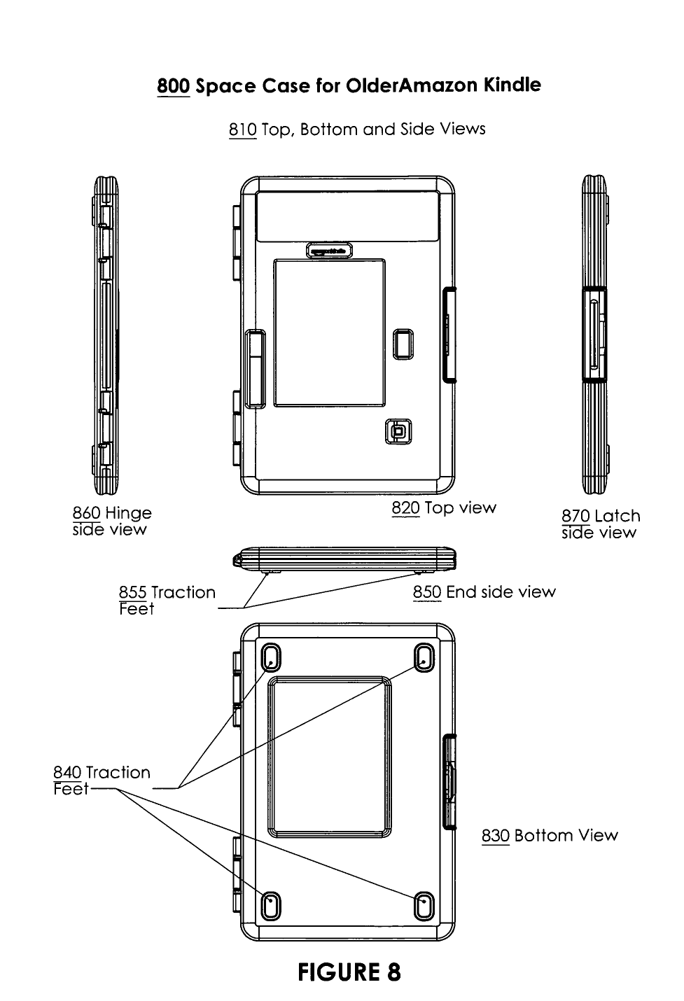

FIG. 8 is a pictorial representation of top, bottom and side views 810 of the Space Case with the Older Kindle in place inside of it in accordance with the preferred embodiment of the present invention 800. Again, except for the button and logo placement as shown on the top view 820 this embodiment of the invention is essentially the same as that for the Kindle LG including the latch side view 870 and the hinge side view 860 showing the traction feet 855 and from the bottom side view 830 showing the positioning of the traction feet 840 as well.

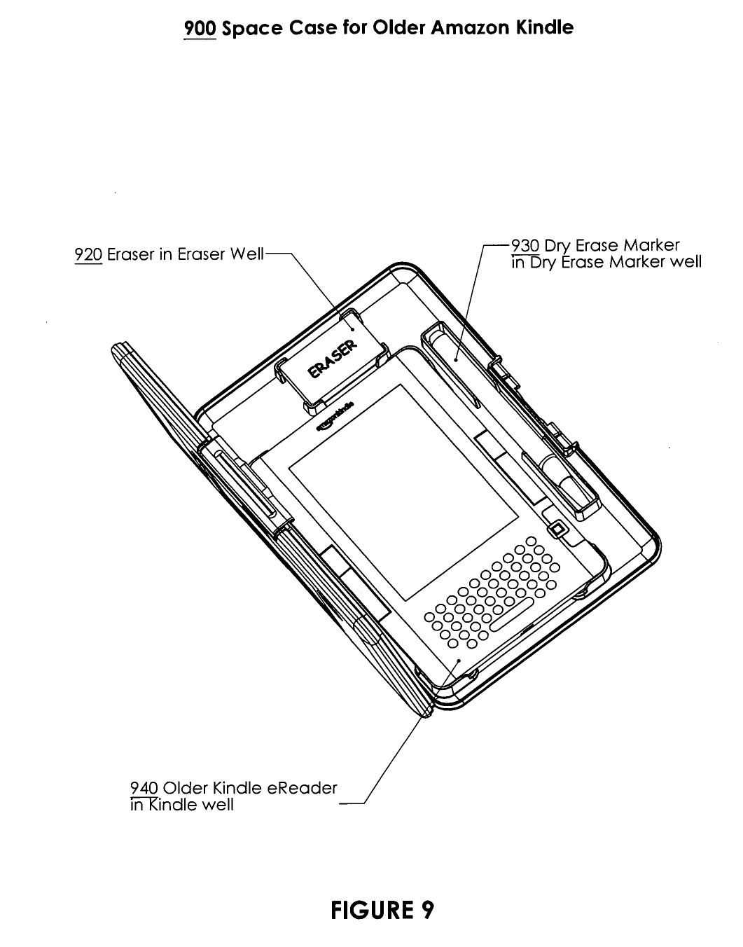

FIG. 9 is a pictorial representation of the Space Case for the Older Kindle with the cover open showing the components stored in their respective wells in accordance with the preferred embodiment of the present invention 900. The placement of the eraser and the eraser well 920 is essentially the same as for the Kindle LG, as are the well for the dry erase marker 930 and the Older Kindle's well 940.

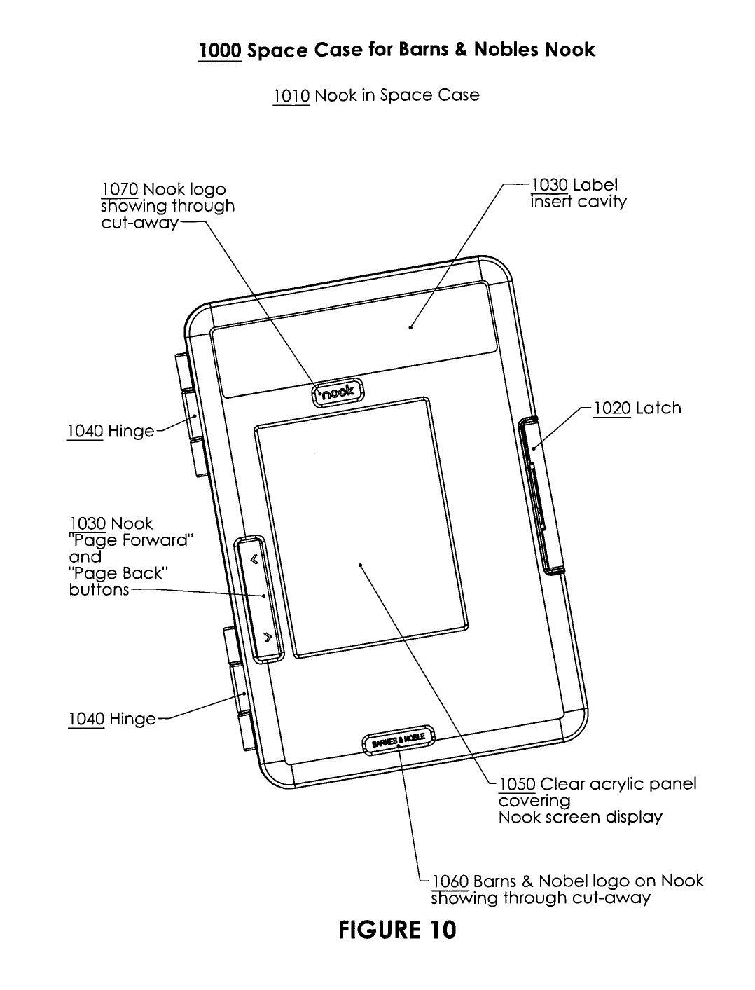

FIG. 10 is a pictorial representation of the Space Case for the Barnes and Nobel Nook eReader, showing the Nook in place in side of the Space Case 1010 in accordance with the preferred embodiment of the present invention 1000. Again, it resembles the two embodiments for the Kindle in that it features the same relative latch 1020 hinge 1040 label insert 1030 cavity and clear acrylic panel 1050 covering the Nook's eInk screen display. There are some significant differences, however. While there is a cut-out for the Nook logo at the top of the device 1070 as was provided for on the Kindle versions, the Nook also has a Barnes and Noble logo located at the bottom of the device and so the cover of this Space Board version has a cut-out in the cover for it, as well 1060. And while it has similar cut-outs in the cover for the page forward and page back buttons of the Nook 1030 in this particular embodiment there are no cut-outs in the cover for the Nook's other control buttons, because it doesn't have any other ones. It has a touch-screen control panel, and any extraneous “touches” will through the Nook into different unwanted modes when the child is writing, so they are not exposed to extraneous “touches”.

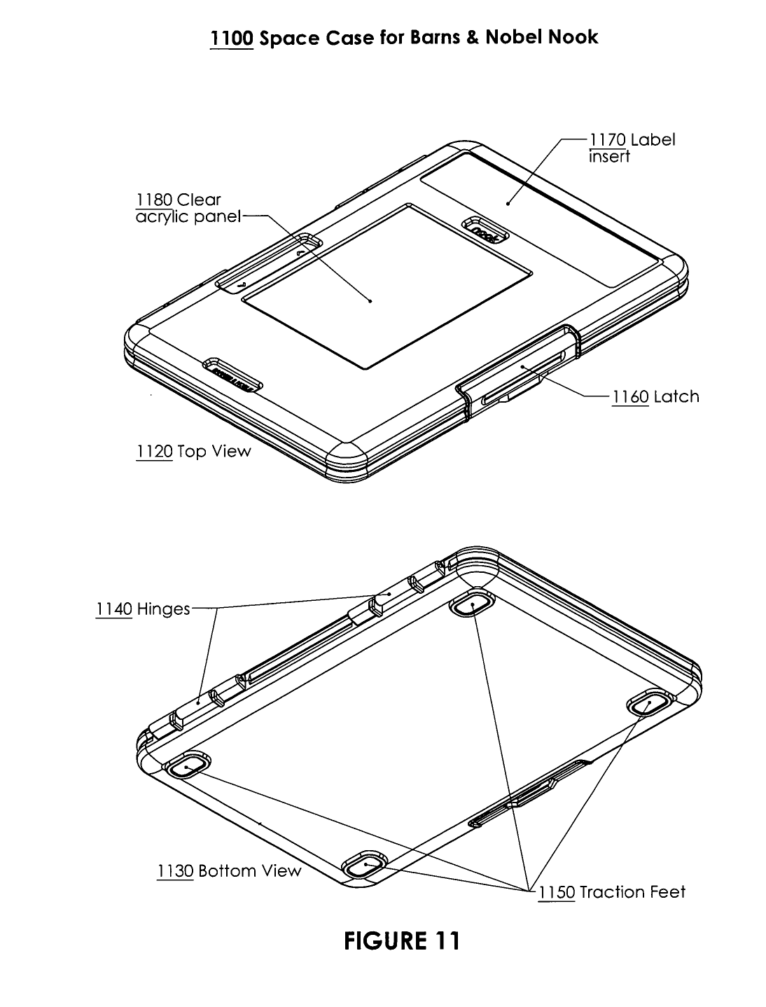

FIG. 11 is a pictorial representation of top and bottom perspective views of the Space Case for the Nook, with the Nook in place inside of it in accordance with the preferred embodiment of the present invention 1100. Again, except for the treatment of the extra logo at the bottom of the cover and the other “missing” control buttons, the top view 1120 perspective and bottom view 1130 perspectives demonstrate the essential similarity of the Nook Space Board to those designed for the two Kindles, including the label insert 1170, the clear acrylic panel over the Nook's display screen 1180, the latch used to secure the cover 1160, the hinges 1140 and the traction feet 1150 located on the bottom of the device.

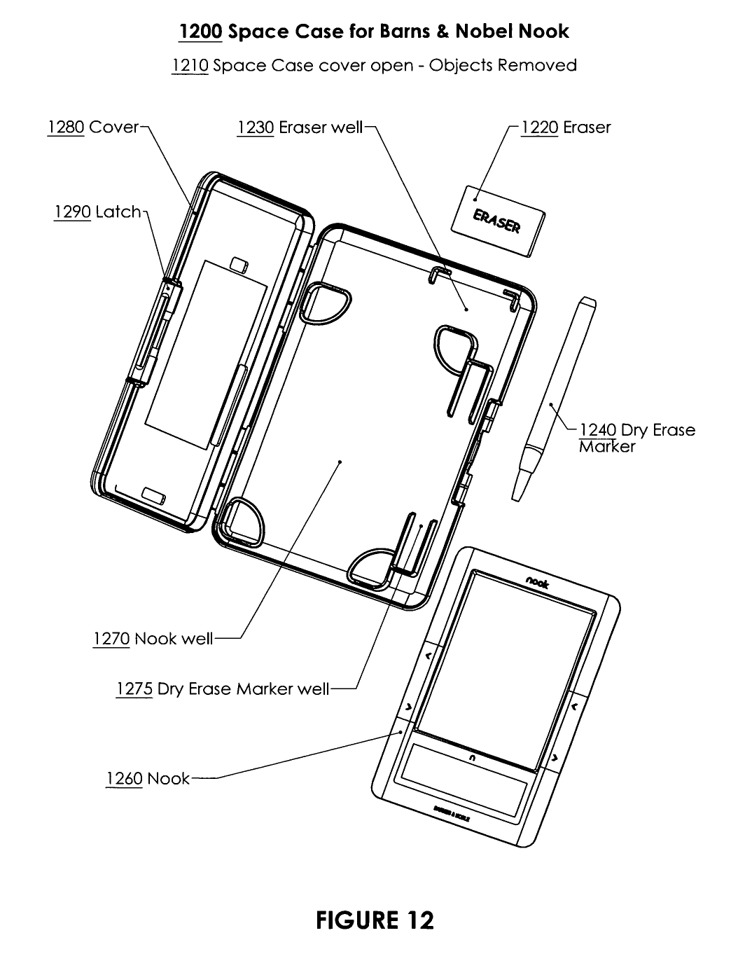

FIG. 12 is a pictorial representation of the top view of the Space Case for the Nook 1210 with the cover open showing the writing components and the Nook eReader outside of the device in accordance with the preferred embodiment of the present invention 1200. The arrangement of the components stored inside the case is again very similar to that of the Kindles, with the exception of there being no need for the keyboard insert inside the cover, as there is no physical keyboard, but rather only a “virtual” one displayed on the control screen at the bottom of the Nook 1260. Otherwise, the cover 1280 and latch 1290 are used to secure the components inside the device when the eraser 1220 is placed in the eraser well 1230, the dry erase marker 1240 is placed in the dry erase marker well 1275 and the Nook 1260 is placed in the Nook well 1270.

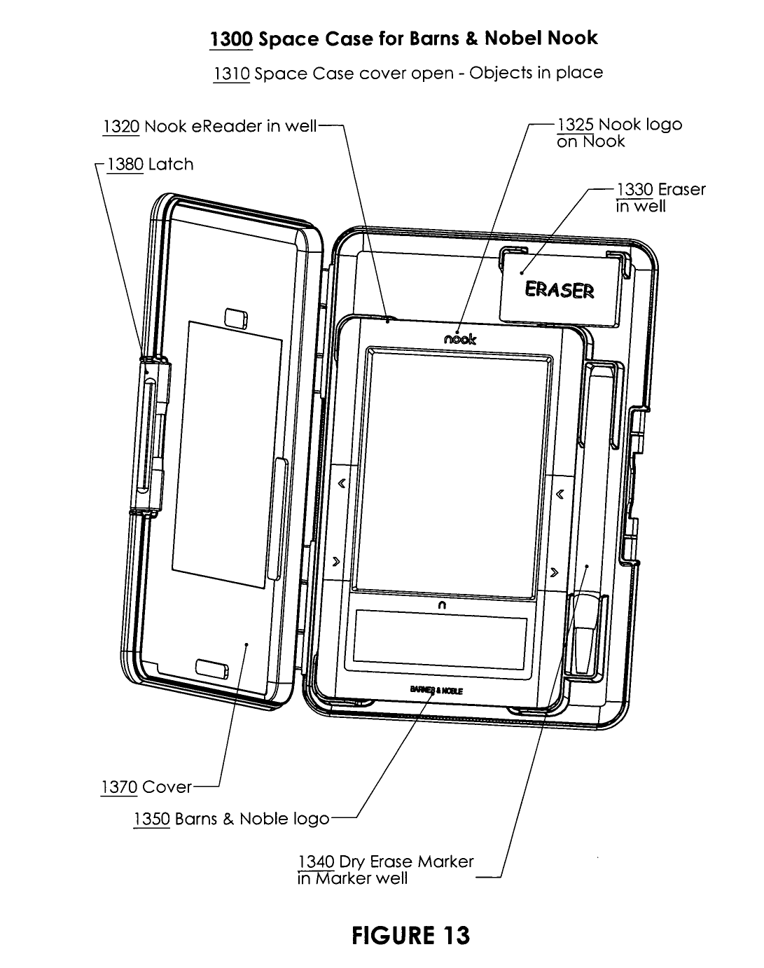

FIG. 13 is a pictorial representation of the top view of the Space Case for the Nook 1310 with the cover opened and with the writing objects and the Nook in place inside in accordance with the preferred embodiment of the present invention 1300. Again, the similarity to the Space Case for the Kindles is depicted, with the latch 1380 and cover 1370 used to close and secure the erase in its well 1330, the dry erase marker in its well 1340, the Nook in its well 1320. Another similarity is the Nook logo at the top of the device 1325 having a cut out, however the cover cut-out for the logo at the bottom of the Nook eReader 1350 is unique to this version of Space Case for esthetic and marketing considerations only, and has no functional value.

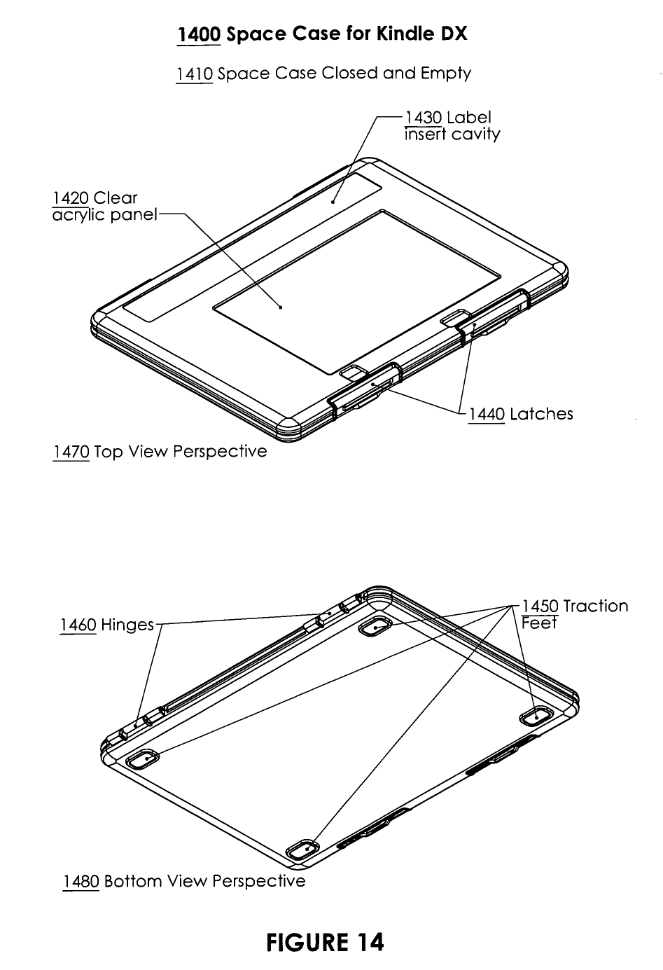

FIG. 14 is a pictorial representation of the top and bottom perspective views 1410 of the Space Case for the Amazon Kindle DX in accordance with the preferred embodiment of the present invention 1400. This is the largest Kindle device and requires the addition of and a second latch 1440 to properly secure the eReader into the device when the cover is closed. The top perspective view 1470 shows the changed placement of the Label insert cavity 1430 along the long-end of the device and the clear acrylic panel 1420 is positioned over the Kindle DX's larger screen display. The bottom perspective view 1480 shows few changes to the configuration of the device on that end, as the hinges 1460 and traction feet 1450 are simply further apart than on the smaller Space Case devices. A cut-out (not shown) in the cover would allow the Kindle DX logo to show through the cover, as in all the other Space Case devices.

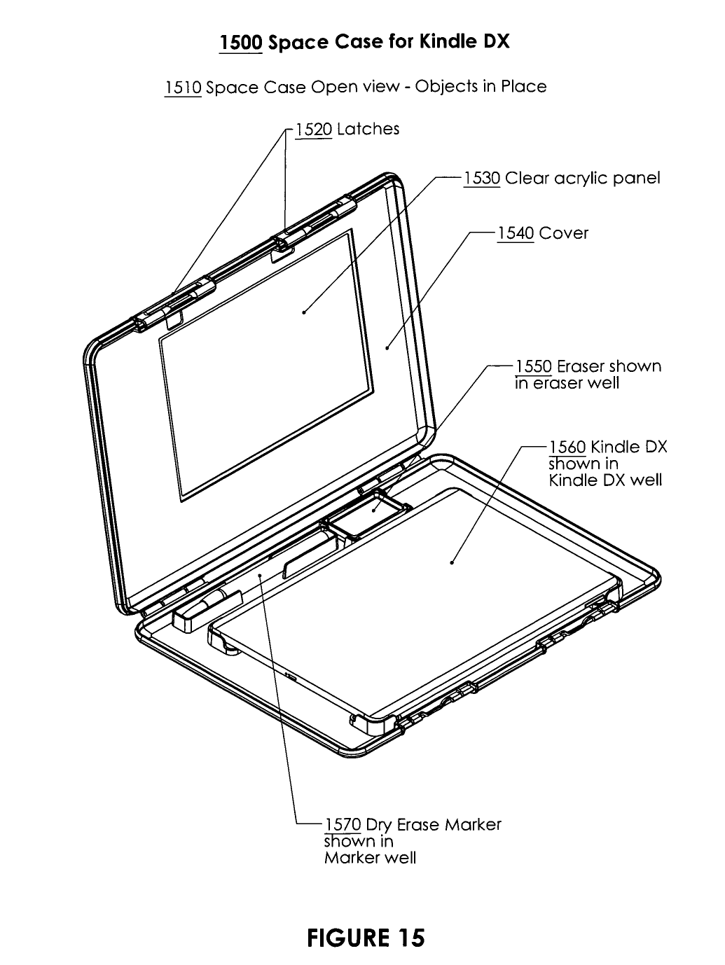

FIG. 15 is a pictorial representation of the Space Case for the Kindle DX with the cover open 1510 and the writing objects and the Kindle DX in their respective storage wells in accordance with the preferred embodiment of the present invention 1500. This perspective view shows the rearrangement and repositioning of the eraser well 1550, the dry erase marker well 1570 and the Kindle DX well 1560 to each other to accommodate the unique size and other characteristics of the Kindle DX. Also shown are the cover 1540 with the twin latch assembly 1520 and the clear acrylic panel 1530 which will position over the Kindle DX's screen display (not shown).

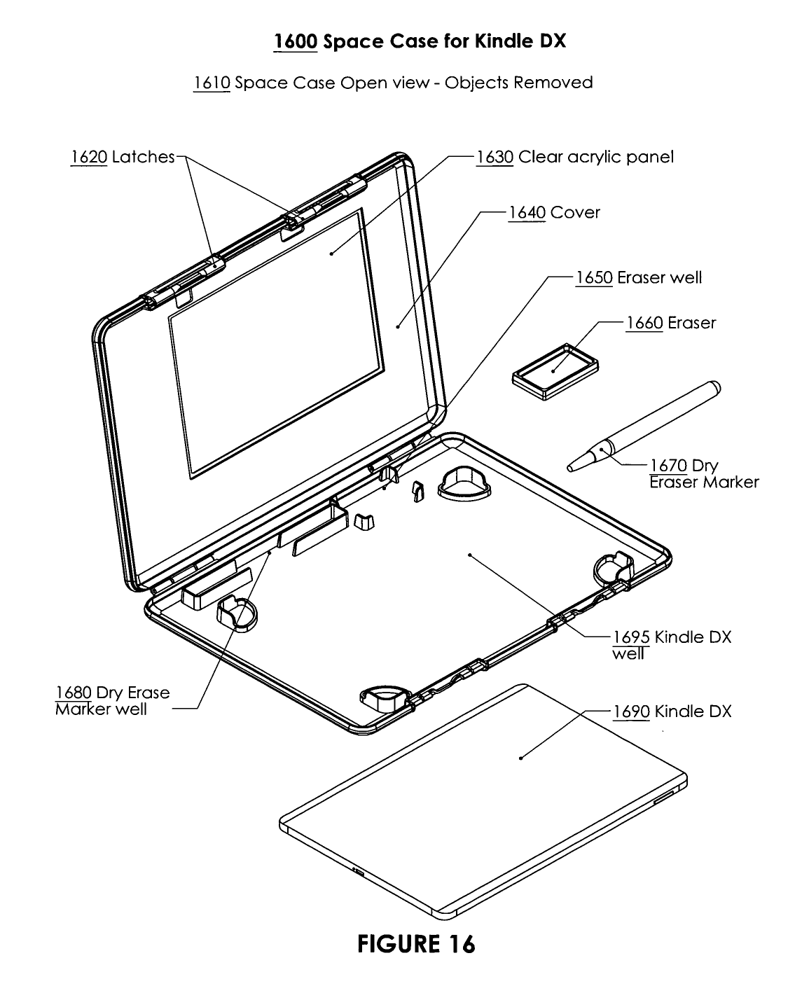

FIG. 16 is a pictorial representation of the Space Case for the Kindle DX with the cover open 1610 and the writing objects and the Kindle DX removed from the device in accordance with the preferred embodiment of the present invention 1600. This perspective view shows the rearrangement and repositioning of the various “wells” more clearly with all the objects removed from the device. The eraser well 1650, the dry erase marker well 1680 and the Kindle DX well 1695 are more clearly seen than in the previous figure, with the erase 1650, the dry erase marker 1670 and he Kindle DX removed from the device. Also shown are the cover 1640 with the twin latch assembly 1620 and the clear acrylic panel 1630 which will position over the Kindle DX's screen display (not shown).

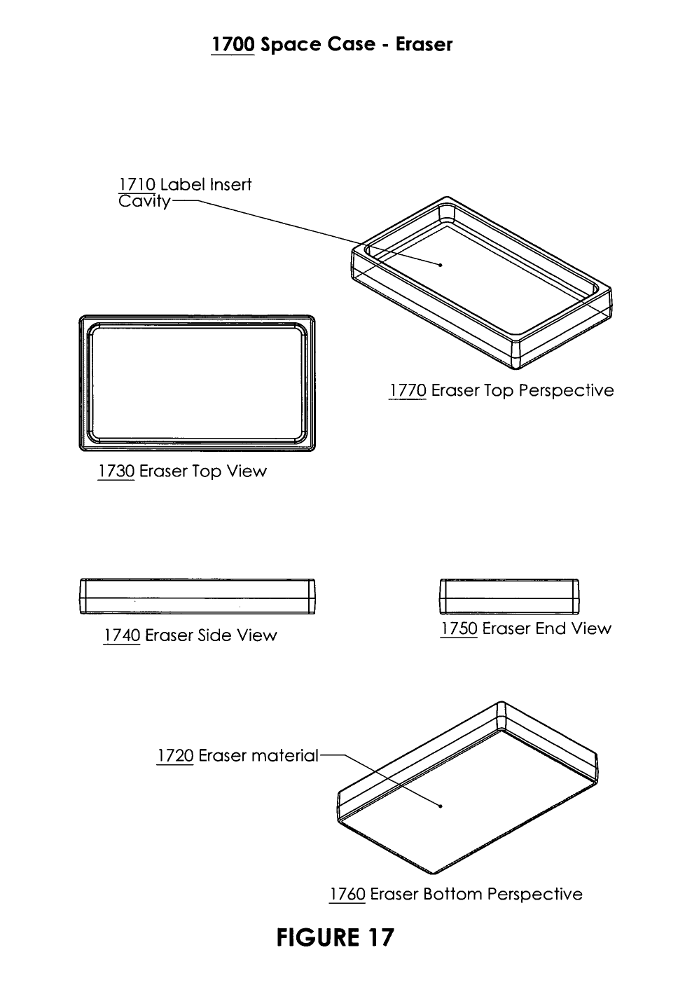

FIG. 17 is a pictorial representation showing top, bottom, side and perspective views of the injection-molded Space Case Eraser in accordance with the preferred embodiment of the present invention 1700. The top perspective view 1770 shows the unique label insert cavity 1710 into which durable multi-color custom acrylic labels may be inserted and adhered (glued). This is further shown in the eraser top view 1730, with the raised sides depicted on the side view 1740 and the end view 1750. The eraser material 1720 such as felt of micro fiber material is die-cut to size with adhesive backing and adhered to the erase bottom 1760.

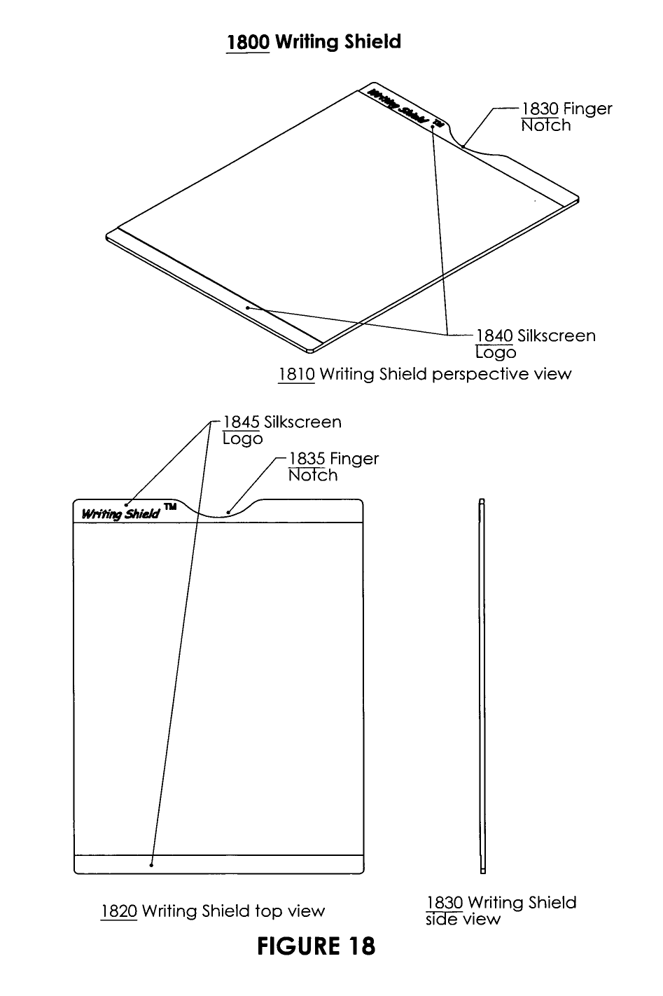

FIG. 18 is a pictorial representation of the Writing Shield with the Finger Notch located on one of the shorter ends of the device in accordance with the preferred embodiment of the present invention 1800. The Writing Shield in this embodiment can either be either made of clear acrylic and CNC router precision cut for its unique shape and size or be made out of clear lexan polycarbonate plastic and die cut to achieve its unique size and shape. The perspective view 1810 shows the finger notch 1830 in this version positioned along the top shorter end of the device, with the top and bottom short ends with the silk-screened logo and other company information 1840. Likewise the front view 1820 (top view if laying flat on a surface, such as the eInk display screen) shows the full size and shape of the finger notch 1835 and better shows the logo area silk-screened along the narrow ends of the device 1845. The side view 1830 shows the thin profile of the clear plastic sheet.

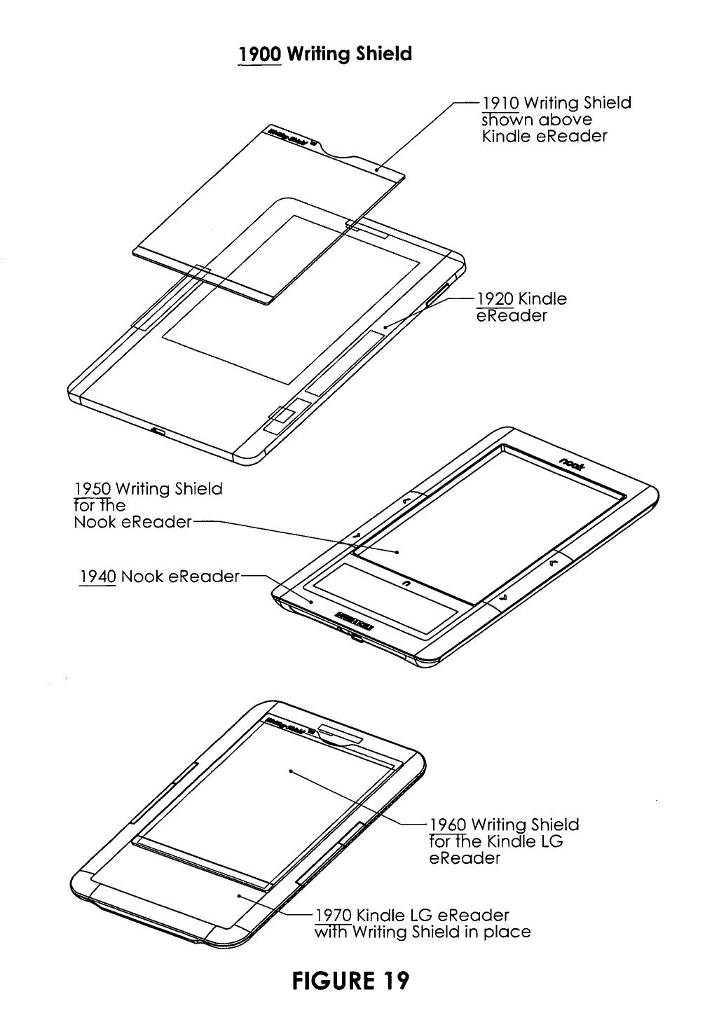

FIG. 19 is a pictorial representation of the Writing Shield being inserted onto the display screens of an Older Kindle, a Kindle LG and a Nook eReader in accordance with the preferred embodiment of the present invention 1900. The Writing Shield is placed above the eReader display panel and simply inserted into the screen area cavity that surrounds the display screen of the Older Kindle eReader 1920, the Nook eReader 1940 or for the Kindle LG eReader 1960. The Writing Shield is shown positioned in place on the Nook eReader 1940 and the Kindle LG eReader, over the screen display 1970. Note that in a larger sized embodiment, the Writing Shield may be configured for the Kindle DX or other large format eReaders, as well.

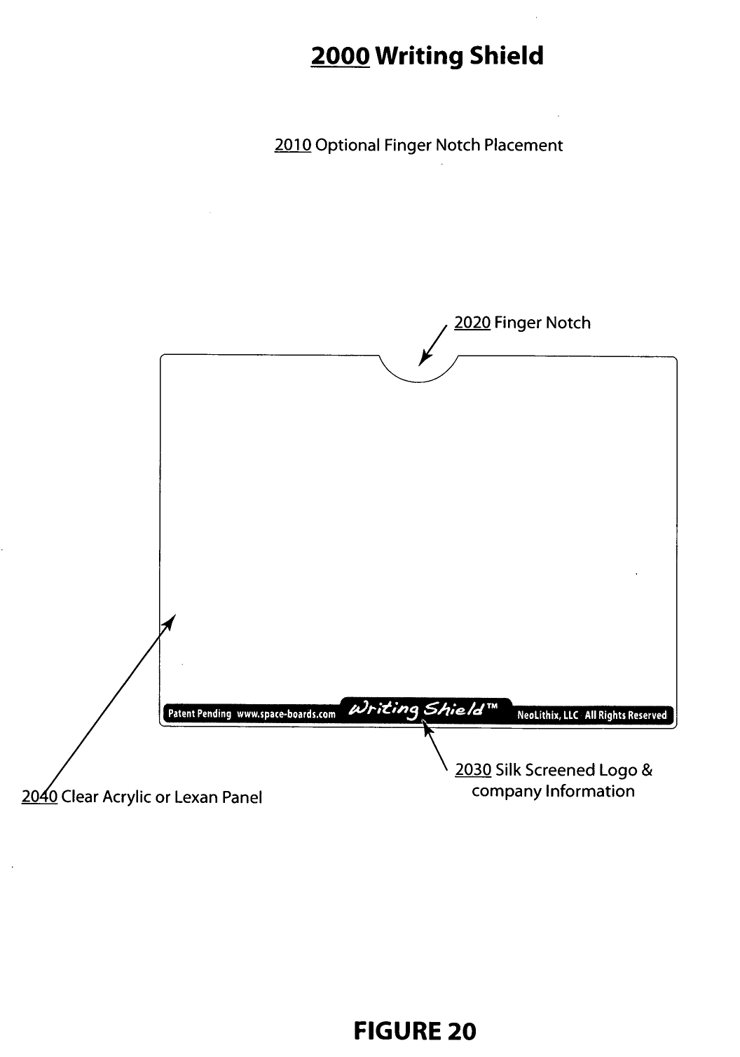

FIG. 20 is a pictorial representation showing the front view 2010 of an optional placement of the finger notch 2020 and silk-screened label 2030 in accordance with the preferred embodiment of the present invention 2000. The clear plastic panel component of the Writing Shield in this configuration may likewise be comprised of either clear acrylic or lexan plastic material 2040.

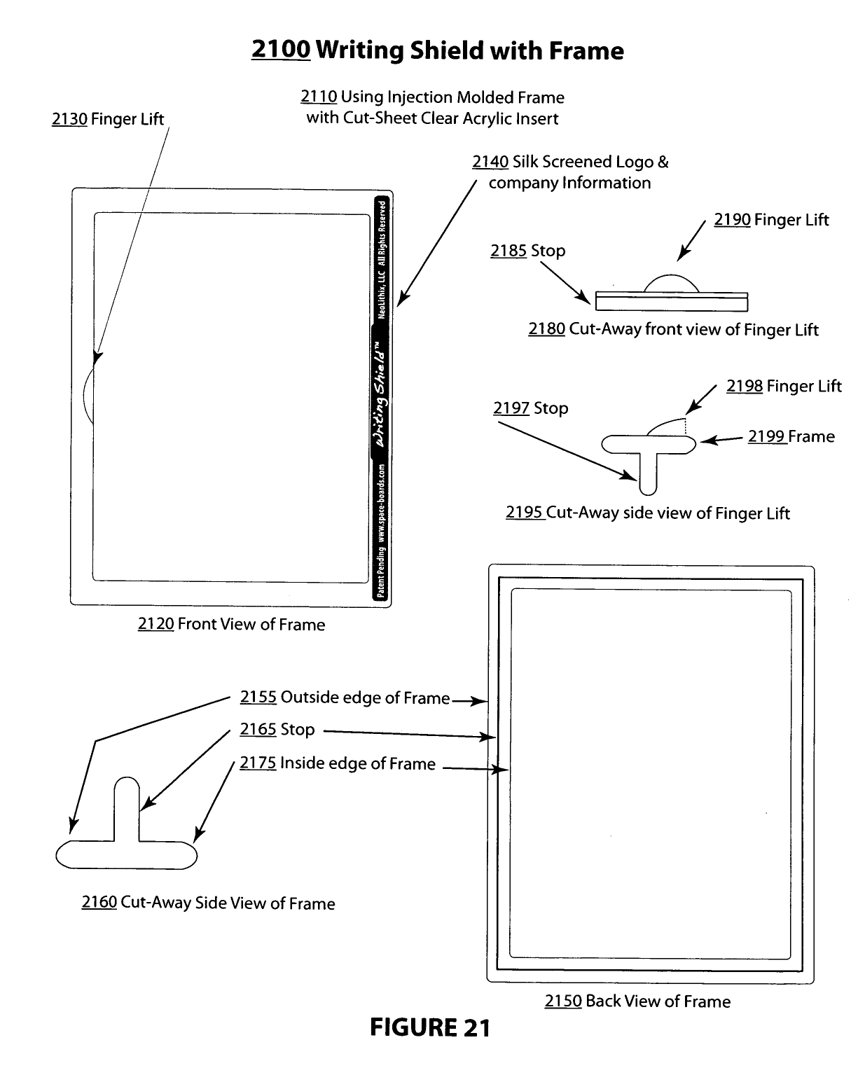

FIG. 21 is a pictorial representation showing front, back and side cut-away views 2110 of another embodiment of the present invention, manufacturing Writing Shields by way of using an injection-molded frame and inserting lower-cost cut-sheet clear Acrylic panels in accordance with the preferred embodiment of the present invention 2100. This embodiment is comprised first of all of an injection-molded frame, the front view 2120 depicts the finger lift 2130 which replaces the finger notch of the other Writing Shield embodiments and the placement of the silkscreened logo and other company information 2140. The finger lift cut-away front view 2180 and side view of the finger lift and frame shows that the finger lift 2190 is a hollow raised area protruding from the frame into which one may insert a finger tip or nail and lift the frame from its seating on an eReader screen display, in place of using the finger notch for the same purpose. The finger lift 2198 is further shown in a side cut-away view 2195 to show its relationship to the frame 2199 and the stop 2197 located underneath the surface of the frame. The stop facilitates the proper lateral positioning of the clear acrylic panel as will be shown in the drawing that follows this figure. The back view of frame 2150 and the cut-away side view of the frame 2160 show the structure and relationship of the outside edge 2155, the stop 2165 and the inside edge 2175 of the frame.

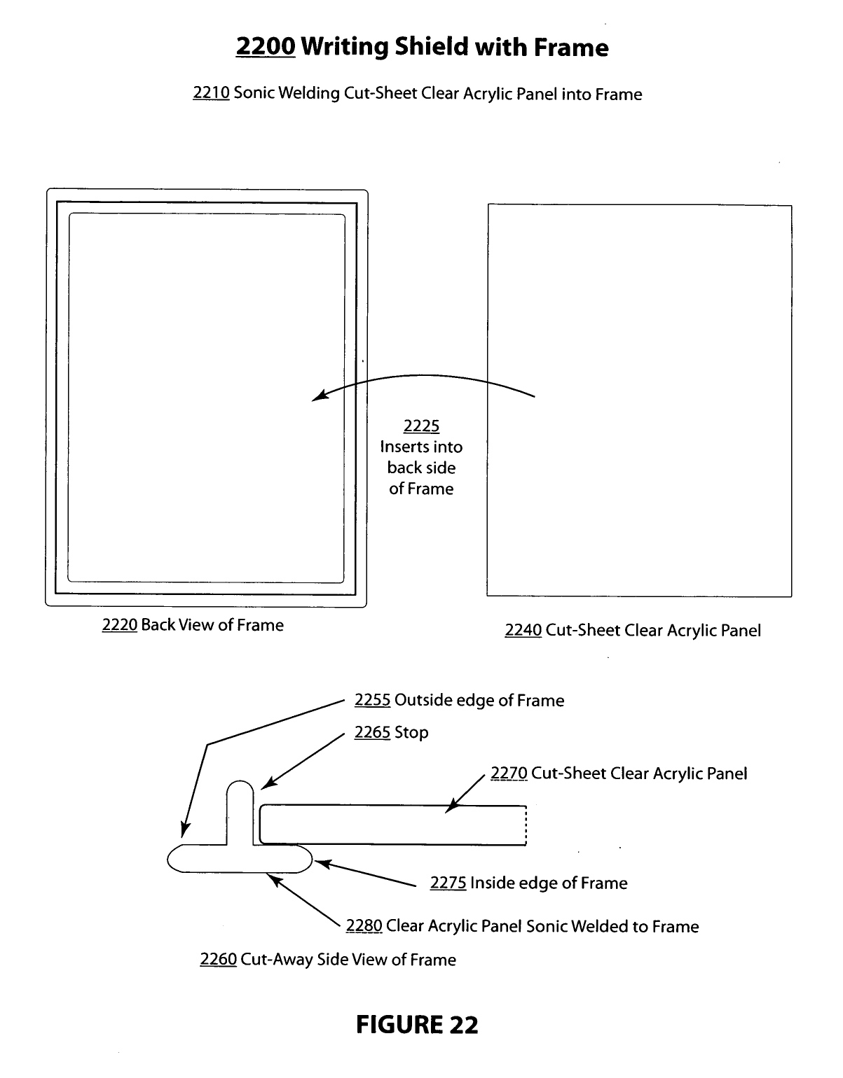

FIG. 22 is a pictorial representation showing the insertion of the cut-sheet clear acrylic panel into the back of the Writing Shield and sonic welding (or gluing) it to the frame 2210 in accordance with the preferred embodiment of the present invention 2200. The cut-sheet clear acrylic panel 2240 is inserted 2225 into the back side of the frame 2220. The cut-away side view of the frame 2260 shows the cut-sheet clear acrylic panel 2270 positioned on the inside edge of the frame 2275 resting next to the stop 2265 where it is then sonic welded 2280 (or glued) in position to the frame. The outside edge of the frame 2255 is shown for reference only. As stated previously in this document, the advantages of this embodiment are both esthetic and economic. The injection molded frame has a more polished and finished look and can be produced in a wide variety of “kid-colors” and the costs of cutting the clear acrylic panels rather than CNC routing them is a savings of a factor of many times the cost of the plastic panel itself.

Although the invention has been described with reference to a particular embodiment, this description is not meant to be construed in a limiting sense. Various modifications of the disclosed embodiments as well as alternative embodiments of the invention will become apparent to persons skilled in the art upon reference to the description of the invention. It is therefore contemplated that the appended claims will cover any such modifications or embodiments that fall within the scope of the invention.

What is claimed is:

1. A device for use with a portable electronic eReader device having a display screen, comprising:
a panel of thin, transparent sheet material sized to cover essentially the entire display screen, wherein the panel is removable from the electronic eReader device;
wherein the transparent sheet material is made from a material that can be written on by a marker, and easily erased by hand.

2. The device of claim 1, wherein the panel includes a notch at one end to facilitate removal of the panel by lifting it from the display screen.

3. The device of claim 1, further comprising:
a frame surrounding edges of the panel and attached thereto; and
a gripping portion on the frame wherein the frame can be lifted away from the electronic eReader device to facilitate removal of the panel.

4. The device of claim 1, wherein the panel comprises a sheet of acrylic material.

5. A case for use with a portable electronic eReader device having a display screen, comprising:
a case base portion larger than the electronic eReader device and having a well to hold the electronic eReader device in a fixed position; and
a cover attached to the case base portion, the cover having panel formed from a thin sheet of transparent material defining a window therein, wherein the cover is movable between a closed position and an open position, and further wherein the panel is made from a material that can be written on by a marker, and easily erased by hand;
wherein, when the cover is in the closed position, the window is positioned to align with and cover the display screen.

6. The case of claim 5, wherein the cover is attached to the case base using a hinge.

7. The case of claim 5, wherein the case base is larger than the electronic eReader device, and includes at least one holding point for holding a dry erase marker in a fixed position, wherein the dry erase marker is accessible when the cover is in the open position.

8. The case of claim 7, wherein the case base further includes a least a second holding point for holding an eraser in a fixed position, wherein the eraser is accessible when the cover is in the open position.

9. The case of claim 5, wherein the electronic eReader device can be removed from the well when the cover is in the open position.

10. The case of claim 5, further comprising:
a plurality of traction feet attached to a back side of the case base opposite the cover, wherein the traction feet are made from a material that inhibits sliding of the case when it is resting on a flat surface.

11. The case of claim 5, wherein the electronic eReader device has a first thickness in a direction normal to the display screen, and wherein the case base and cover combined have a thickness less than approximately 200 percent of the first thickness.

12. The case of claim 5, wherein the case base and cover are made from impact resistant materials that provide impact protection for the electronic eReader device when the device is held in the well and the cover is in the closed position.

13. A method of using an electronic eReader device having a display screen, comprising the steps of:
positioning a panel of thin, transparent sheet material over the display screen and holding the panel in place;
in response to material displayed on the display screen, writing on the panel with a marker; and
erasing the information written on the panel with an eraser.

14. The method of claim 13, wherein the marker is a dry erase marker, and the eraser is a dry eraser.

15. The method of claim 13, wherein the step of positioning a panel comprises the steps of:
providing a case having a well sized to hold the electronic eReader device in a base portion thereof; and
closing a cover attached to the base portion, wherein the cover includes a panel of thin, transparent sheet material that defines a window, and wherein the window is aligned with the display screen when the cover is closed.
